(19) United States
(12) Patent Application Publication
(10) Pub. No.: US 2006/0180968 A1
(43) Pub. Date: Aug. 17, 2006

(54) Semiconductor manufacturing apparatus

(76) Inventors: Kyung Sun Kim, Suwon-Si (KR); Jung Wook Kim, Seongnam-Si (KR); Yun Kwang Jeon, Seoul (KR); Jin Seok Lee, Seoul (KR)

Correspondence Address: STANZIONE & KIM, LLP, 919 18TH STREET, N.W., SUITE 440, WASHINGTON, DC, 20006, US

(21) Appl. No.: 11/149,202

(22) Filed: Jun. 10, 2005

(30) Foreign Application Priority Data
Jan. 24, 2005 (KR) 2005-6440

(51) Int. Cl. B23Q 1/00

(52) U.S. Cl. 269/51

(57) ABSTRACT

A semiconductor manufacturing apparatus includes a body having a reaction chamber formed therein to process a semiconductor wafer, a chuck provided within the reaction chamber to support the semiconductor wafer, a chuck rotating device provided within the reaction chamber to support and rotate the chuck, and a slant adjuster to support the chuck rotating device and to adjust a position of the chuck rotating device to adjust a slant of an upper surface of the chuck.

### CROSS-REFERENCE TO RELATED APPLICATIONS

This application claims the benefit under 35 U.S.C. §119 of Korean Patent Application No. 2005-6440, filed on Jan. 24, 2005, in the Korean Intellectual Property Office, the disclosure of which is incorporated herein in its entirety by reference.

### BACKGROUND OF THE INVENTION

1. Field of the Invention

The present general inventive concept relates to a semiconductor manufacturing apparatus, and more particularly, to a semiconductor manufacturing apparatus designed to adjust a slant of a chuck to uniformly process a semiconductor wafer.

2. Description of the Related Art

A conventional semiconductor manufacturing apparatus for performing a typical deposition or etching process is disclosed in U.S. Pat. No. 6,486,081. The conventional semiconductor manufacturing apparatus disclosed therein comprises a body including a reaction chamber in a vacuum state, a chuck provided within the reaction chamber to support a semiconductor wafer, and a plurality of gas supplying nozzles for injecting a processing gas into the reaction chamber. The plurality of gas supplying nozzles are provided around a periphery of an upper surface of the reaction chamber and at a center of the upper surface of the reaction chamber to supply the processing gas toward an upper portion of the reaction chamber.

With such a conventional semiconductor manufacturing apparatus, a process, such as the deposition process or the etching process, can be uniformly performed on the semiconductor wafer when the processing gas is uniformly distributed above the semiconductor wafer from the gas supplying nozzles.

However, in the conventional semiconductor manufacturing apparatus as described above, as pressure in the chamber or flow and supply conditions of the processing gas change during the process, the distribution of the processing gas becomes non-uniform, and in this case, it is difficult to correct the non-uniform distribution of the processing gas. This is because both the chuck for supporting the semiconductor wafer and the gas supplying nozzles are fixed in place, thereby making it difficult to correct processing conditions even if an operator recognizes the non-uniform distribution of the processing gas during the process.

U.S. Pat. No. 6,634,650 discloses a conventional semiconductor manufacturing apparatus comprising a rotational chuck. In this apparatus, a chuck supporting a semiconductor wafer is rotated while a process is performed, so that processing gas can be more uniformly distributed above the semiconductor wafer. However, in this construction, since the chuck is only rotated, overall uniformity of the process on the substrate is limited when the processing gas is concentrated at a particular position.

### SUMMARY OF THE INVENTION

The present general inventive concept provides a semiconductor manufacturing apparatus designed to rotate and adjust a slant of a chuck to support a semiconductor wafer, thereby ensuring uniform distribution of a processing gas over an entirety of the semiconductor wafer.

The present general inventive concept also provides a semiconductor manufacturing apparatus designed to allow a coolant and power to be supplied to a rotating chuck.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a semiconductor manufacturing apparatus, including a body having a reaction chamber formed therein to process a semiconductor wafer, a chuck provided within the reaction chamber to support the semiconductor wafer, a chuck rotating device provided within the reaction chamber to support and rotate the chuck, and a slant adjuster to support the chuck rotating device and to adjust a position of the chuck rotating device to adjust a slant of an upper surface of the chuck.

The slant adjuster may include a supporting part to support the chuck rotating device within the reaction chamber, and rotational shafts extending from opposite sides of the supporting part to rotate the supporting part while being supported at opposite sides of the body, respectively, each of the rotational shafts having a rotational axis crossing a rotational axis of the chuck rotating device.

At least one of the rotational shafts may extend externally with respect to the body, and the slant adjuster may further include a driving device provided at an outer portion of the body to rotate the at least one of the rotational shafts extending externally with respect to the body in a clockwise or a counterclockwise direction.

The chuck rotating device may be disposed within the reaction chamber such that the rotational axis thereof is perpendicular to the upper surface of the chuck, and the slant adjuster may be disposed within the reaction chamber such that a rotational axis of the slant adjuster is parallel to the upper surface of the chuck.

The chuck rotating device may include a rotating member coupled at an upper end thereof to a lower surface of the chuck and rotatably supported by the supporting part, and a driving device provided at the supporting part to rotate the rotating member in the clockwise or the counterclockwise direction.

The rotating member may have a cylindrical shape, and the driving device may be provided at an outer surface of the rotating member.

The supporting part and the rotational shafts may be formed with a hollow space partitioned from the reaction chamber to communicate with an outside of the body, and the chuck rotating device may be provided within the hollow space of the supporting part.

The semiconductor manufacturing apparatus may further include a sealing member interposed between the lower surface of the chuck and an upper surface of the supporting part to maintain air-tightness between the hollow space of the supporting part and the reaction chamber.

The semiconductor manufacturing apparatus may further include a coolant circulation path formed in the chuck to circulate a coolant in the chuck and having an inlet and an outlet provided at the lower surface of the chuck, a path connecting member provided at an inner center portion of the rotating member to contact the lower surface of the chuck and including a coolant supplying path and a coolant discharging path fixed in the supporting part and connected to the inlet and outlet of the coolant circulation path, respectively, and coolant pipes extending from the coolant supplying and discharging paths of the path connecting member externally with respect to the body through the supporting part and the rotational shafts.

The inlet of the coolant circulation path may be provided at a rotational center position of the chuck, and the outlet of the coolant circulation path may be provided at a position offset from the rotational center position of the chuck. The coolant supplying path and the coolant discharging path may be provided at positions corresponding to the inlet and the outlet of the coolant circulation path, respectively. The path connecting member may be provided with a ring-shaped groove formed along a rotating trajectory of the outlet of the coolant circulation path on a top surface of the path connecting member to contact the lower surface of the chuck such that even if the chuck is rotated, the outlet of the coolant circulation path is connected to the coolant discharging path.

The semiconductor manufacturing apparatus may further include sealing members respectively provided at inner and outer portions of the ring-shaped groove between the lower surface of the chuck and the upper end of the path connecting member to partition the coolant supply path and the coolant discharging path.

The supporting part may be provided with a brush-shaped power source connecting member to contact the rotating member to apply power to the chuck.

The semiconductor manufacturing apparatus may further include a first pin provided at the chuck to be lifted or lowered to separate the semiconductor wafer from the chuck, a second pin provided at a position corresponding to the first pin to be lifted or lowered in the supporting part in order to lift or lower the first pin, and a lifter provided in the supporting part to lift or lower the second pin.

The foregoing and/or other aspects of the present general inventive concept may also be achieved by providing a semiconductor manufacturing apparatus including a body having a reaction chamber formed therein to process a semiconductor wafer, a chuck provided within the reaction chamber to support the semiconductor wafer, and a slant adjuster rotatably provided at the body to support the chuck while adjusting a slant of the chuck.

### BRIEF DESCRIPTION OF THE DRAWINGS

These and/or other aspects of the general inventive concept will become apparent and more readily appreciated from the following description of the embodiments, taken in conjunction with the accompanying drawings, of which:

FIG. 1 is a cross-sectional view illustrating a semiconductor manufacturing apparatus according to an embodiment of the present general inventive concept;

FIG. 2 is a perspective view illustrating main components of the semiconductor manufacturing apparatus of FIG. 1; and

FIG. 3 is a detailed cross-sectional view illustrating a power source connecting member and a substrate-separating device of the semiconductor manufacturing apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings. The embodiments are described below to explain the present general inventive concept while referring to the figures.

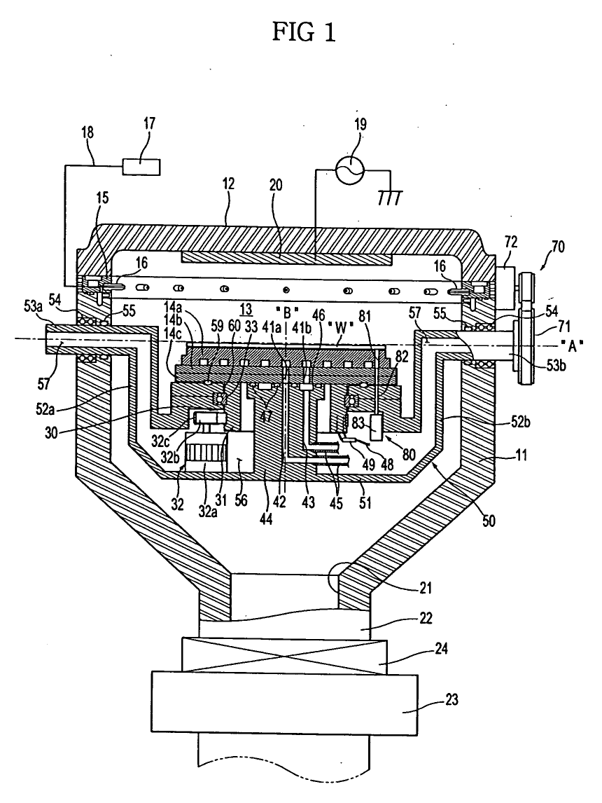

FIGS. 1-3 illustrate a semiconductor manufacturing apparatus according to an embodiment of the present general inventive concept. Referring to FIGS. 1-3, the semiconductor manufacturing apparatus includes a cylindrical body 11 open at an upper portion thereof and having a reaction chamber 13 to process a semiconductor wafer W therein, and a cover 12 to cover the open upper portion of the body 11.

A chuck 14 is provided within the reaction chamber 13 to support the semiconductor wafer W, and a gas distribution ring 15 is interposed between the upper surface of the body 11 and the cover 12. The gas distribution ring 15 includes a plurality of gas supply nozzles 16 to supply a processing gas into the reaction chamber 13. The gas distribution ring 15 has a path formed therein to distribute the processing gas to the respective gas supplying nozzles 16, and communicates with an outer gas supplier 17 through a pipe 18 to supply the processing gas into the reaction chamber 13. The cover 12 is equipped with an upper electrode 20 to which power from a radio frequency power source 19 is applied in order to generate plasma using the processing gas supplied into the reaction chamber 13.

A discharge port 21 is formed through a bottom portion of the body 11 to discharge non-reactant processing gas and reactant by-products externally from the reaction chamber 13. The discharge port 21 is connected to a discharge pipe 22 to which a vacuum pump 23 and a pressure controller 24 are connected to maintain a vacuum state within the reaction chamber 13.

The semiconductor manufacturing apparatus constructed as described above may be utilized to perform a deposition process to form a film on a surface of the semiconductor wafer W or an etching process to etch the film on the surface of the semiconductor wafer W by controlling the processing gas supplied into the reaction chamber 13 and process parameters. The deposition process can be performed in such a manner that the plasma is generated using a silane (SiH₄) gas and an oxygen gas supplied into the reaction chamber 13, and is used for deposition on the semiconductor wafer after controlling the process parameters so as to be appropriate for the deposition process. The etching process can be performed in such a manner that plasma is generated using a trifluoromethane (CHF₃) gas and the like supplied into the reaction chamber 13, and is used for etching of the semiconductor wafer after controlling the process parameters so as to be appropriate for etching. In respective processes, the process parameters may include pressure, temperature, time, and the like, as well as conditions of the processing gas.

The semiconductor manufacturing apparatus further includes a chuck rotating device 30 to rotate the chuck 14 so as to allow the processing gas supplied from the gas supplying nozzles 16 to be uniformly distributed over the surface of the semiconductor wafer W, thereby allowing the process, such as the deposition or the etching, to be uniformly performed over the surface of the semiconductor wafer W, and a slant adjuster 50 to support the chuck rotating device 30 and to adjust a slant of the chuck 14 by changing a position of the chuck rotating device 30.

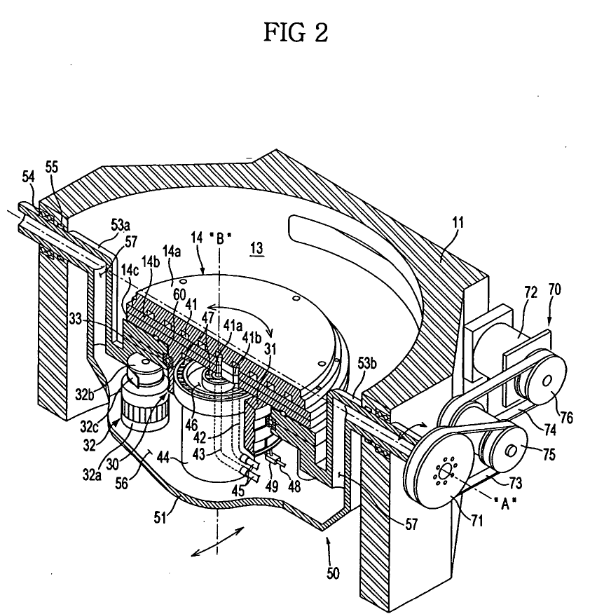

As illustrated in FIGS. 1 and 2, the slant adjuster 50 includes a supporting part 51 to support the chuck rotating device 30 within the reaction chamber 13, extensions 52a and 52b extending a predetermined length from opposite sides of the supporting part 51, rotational shafts 53a and 53b bending from the extensions 52a and 52b and extending externally of the body 11 and rotatably supported at opposite side surfaces of the body 11, respectively, and a driving device 70 provided at an outer surface of the body 11 to rotate one of the rotational shafts 53b extending externally of the body 11 in a clockwise or a counterclockwise direction. The rotational shafts 53a and 53b can be rotatably supported at both side surfaces of the body 11 by bearings 54, and sealing members 55 can be provided at portions of the side surfaces of the body 11 through which the rotational shafts 53a and 53b penetrate, thereby ensuring air-tightness around the portions of the side surfaces of the body 11.

The supporting part 51 of the reaction chamber 13 has a hollow space 56 formed therein to accommodate the chuck rotating device 30, and to communicate externally with respect to the body 11 through hollow spaces 57 respectively formed in the extensions 52a and 52b and the rotational shafts 53a and 53b. An upper surface of the supporting part 51 can have an approximate disk shape so as to support an outer periphery of a lower surface of the chuck 14. A sealing member 59 is interposed between the upper surface of the supporting part 51 and the lower surface of the chuck 14, and partitions an interior portion of the reaction chamber 13 from the hollow space 56. A circular opening 60 is formed at an upper portion of the supporting part 51 to allow the chuck rotating device 30 to be inserted into the hollow space 56 to be supported therein.

As illustrated in FIG. 2, the driving device 70 can include a driven pulley 71 coupled to the rotational shaft 53b extending externally of the body 11, a driving motor 72 to rotate the driven pulley 71 in the clockwise or the counterclockwise direction, an intermediate pulley 75, a driving pulley 76 connected to a shaft of the driving motor 72, and endless belts 73 and 74 connecting the driven pulley 71 and the intermediate pulley 75, and connecting the intermediate pulley 75 and the driving pulley 76, respectively. The driving device, as described above, transfers a rotation of the driving motor 72 to the rotational shaft 53b while reducing a rotational speed of the rotational shaft 53b as compared to the driving motor 72. Although the driving device 70 is illustrating as including the belts 73 and 74 and the pulleys 71, 75, and 76, the driving motor 72 may be directly connected to the rotational shaft 53b, and alternatively, a plurality of gears (not shown) may be utilized to the rotation of the driving motor 72 to the rotational shaft 53b.

As illustrated in FIGS. 1 and 2, the chuck 14 includes a plurality of stacked circular plates 14a, 14b and 14c. More specifically, the chuck 14 includes an upper electrode plate 14a to fix the semiconductor wafer W thereon by use of an electrostatic force caused by application of DC power, and lower insulating plates 14b and 14c below the electrode plate 14a.

The chuck rotating device 30 includes a rotating member 31 coupled to the lower surface of the chuck 14, and a driving device 32 to rotate the rotating member 31. The rotating member 31 is coupled at an end thereof to the lower surface of the chuck 14, and is inserted into the supporting part 51 through the opening 60 of the supporting part 51 such that an outer surface of the rotating member 31 is supported at an inner surface of the opening 60 of the supporting part 51. A bearing 33 is interposed between the outer surface of the rotating member 31 and the inner surface of the opening 60, so that the rotating member 31 is rotatably supported at the inner surface of the opening 60.

The driving device 32 rotates the rotating member 31, and can include a driving motor 32a provided at the outer surface of the rotating member 31 within the hollow space 56 to rotate the rotating member 31 in the clockwise or the counterclockwise direction, a pulley 32b coupled to a shaft of the driving motor 32a, and a belt 32c connecting the pulley 32b and the outer surface of the rotating member 31. With this construction, the rotation of the driving motor 32a can be transmitted to the rotating member 31 at a reduced speed, thus forcing the chuck 14 to rotate. Although the driving device 32 is illustrated as including the belt 32c and the pulley 32b to rotate the rotating member 31, the driving device 32 may alternatively employ gears in order to rotate the rotating member 31.

When constructing the chuck rotating device 30 and the slant adjuster 50, a rotational axis A of the slant adjuster 50 can be positioned in parallel to an upper surface of the chuck 14, and a rotational axis B of the chuck rotating device 30 can be positioned perpendicular to the upper surface of the chuck 14. That is, the rotational axis B of the chuck rotating device 30 can cross the rotational axis A of the slant adjuster 50. Additionally, the rotational axis A of the slant adjuster 50 can be provided at approximately the same position as that of the semiconductor wafer W mounted on the upper surface of the chuck 14. Accordingly, the chuck rotating device 30 and the supporting part 51 to support the chuck rotating device 30 can be lowered below the rotational axis A of the slant adjuster 50 to have a low center of gravity, so that even if the chuck 14 is rotated or the slant of the chuck 14 is changed due to the rotation of the rotational shafts 53a and 53b, the semiconductor wafer W can be stably mounted on the chuck 14.

Additionally, the semiconductor manufacturing apparatus, as illustrated in FIGS. 1-3, can include a cooling device to circulate a coolant in the rotating chuck 14 in order to prevent a temperature of the semiconductor wafer W from being raised during the process on the semiconductor wafer W, and a power supplying device to supply the DC power to the chuck 14 and generate the electrostatic force of the chuck 14 to hold the substrate wafer W mounted on the chuck 14.

The cooling device includes a coolant circulation path 41 formed in the chuck 14 to allow the coolant to circulate in the chuck 14 and having an inlet 41a and an outlet 41b provided at the lower surface of the chuck 14, a path connecting member 44 provided at an inner center portion of the rotating member 31 to force the coolant to circulate towards the coolant circulation path 41 and including a coolant supplying path 42 and a coolant discharging path 43 connected to the inlet 41a and the outlet 41b of the coolant circulation path 41, respectively, and coolant pipes 45 extending externally of the body 11 from the coolant supplying and discharging paths 42 and 43 of the path connecting member 44.

The coolant circulation path 41 in the chuck 14 is constructed such that the coolant flowing into the inlet 41a can be discharged through the outlet 41b after heat exchanging while circulating along the coolant circulation path 41 in the chuck 14. The inlet 41a of the coolant circulation path 41 is provided at a rotational center portion of the chuck 14, and the outlet 41b is provided at a side offset from the inlet 41a.

The path connecting member 44 is fixed at a bottom portion of the supporting part 51, and extends upwardly through the rotating member 31 such that an upper end of the path connecting member 44 contacts the lower surface of the chuck 14. The coolant supplying path 42 is formed at a center portion of the path connecting member 44 to correspond to the inlet 41a of the coolant circulation path 41, and the coolant discharging path 43 is formed to correspond to the outlet 41b of the coolant circulation path 41.

The path connecting member 44 is formed at the upper end thereof with a ring-shaped groove 46 along a rotating trajectory of the outlet 41b of the coolant circulation path 41 such that even if the chuck 14 is rotated, the outlet 41b of the coolant circulation path 41 is connected to the coolant discharging path 43. Additionally, sealing members 47 are respectively equipped to inner and outer portions surrounding the ring-shaped groove 46 between the lower surface of the chuck 14 and the upper end of the path connecting member 44 to partition the coolant supplying path 42 from the coolant discharging path 43 and prevent leakage of the coolant. The coolant pipes 45 are connected at one side thereof to the coolant supplying and discharging paths 42 and 43, respectively. Furthermore, although not shown in the drawings, the coolant pipes 45 extend externally of the body 11 through the hollow spaces 56 and 57 within the supporting part 51 and the rotational shaft 53, and connect to the coolant supplier (not shown).

A power supplying device to supply the DC power to the chuck 14 includes a power source connecting member 49 provided below a bottom portion of the rotating member 31 and connected to the bottom portion of the rotating member 31 within the supporting part 51, and an electric wire 48 extending from the power source connecting member 49 through the hollow space 56 of the supporting part 51 and the hollow space 57 of the rotational shaft 53. The power source connecting member 49 is provided with conductive metallic thin plates 49a and 49b which contact connection rings 49c and 49d connected to the bottom portion of the rotating member 31, so that the power source connecting member 49 supplies power to the chuck 14 therethrough. In other words, the connection rings 49c and 49d rotate together with the rotating member 31, and contact the metallic thin plates 49a and 49b of the power source connecting member 49, the power source connecting member 47 supplies the power to the rotating member 31. Since the rotating member 31 rotates together with the chuck 14, the power applied to the rotating member 31 may also be supplied to the chuck 14 via a separate electric wire. Since methods of causing the chuck to generate an electrostatic force via the DC power applied to the chuck 14 are well known in the art, a detailed description thereof will be omitted.

The semiconductor manufacturing apparatus can further include a separating device 80 to separate the semiconductor wafer W from the chuck 14 by lifting the semiconductor wafer W after completion of the processing of the semiconductor wafer W or to mount the semiconductor wafer W into the reaction chamber 13 to process the semiconductor wafer W.

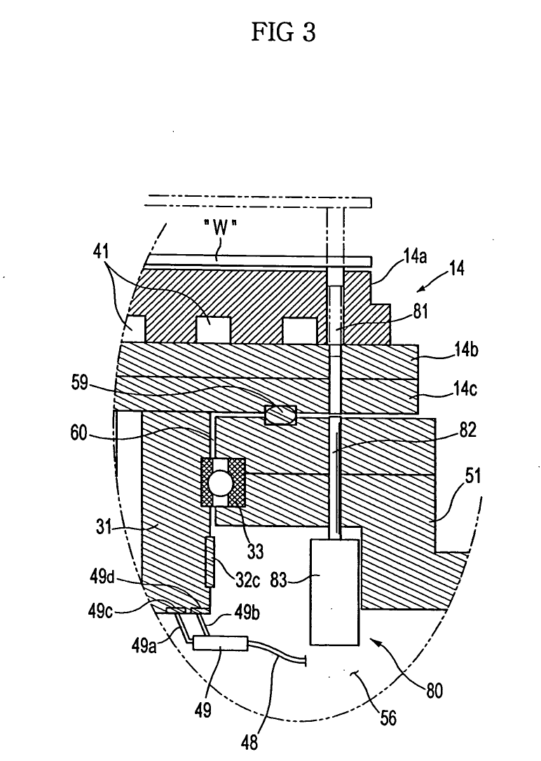

As illustrated in FIG. 3, the separating device 80 includes a first pin 81 provided in the chuck 14 to be raised or lowered therein, a second pin 82 provided at a position in the supporting part 51 corresponding to the first pin 51 to be raised or lowered therein in order to raise or lower the first pin 51, and a lifter 83 provided in the supporting part 51 to raise or lower the second pin 82. The lifter 83 may comprise a hydraulic pressure cylinder or a solenoid type driving device.

The separating device 80 is designed such that the first pin 81 rotates together with the chuck 14 while the second pin 82 can be lowered and maintained in a stopped state. When the process is completed and an operator wishes to separate the semiconductor wafer W from the chuck 14, the lifter 83 is activated to raise the second pin 82 in a state in which the first pin 81 is precisely aligned with the second pin 82, so that the semiconductor wafer W is raised from the chuck 14. In other words, the second pin 82 pushes the first pin 81 up in the state in which the first pin 81 is precisely aligned with the second pin 82, so that the semiconductor wafer W is raised from the chuck 14.

Operations of the chuck rotating device 30 and the slant adjuster 50 of the semiconductor manufacturing apparatus as described above will now be described.

With the reaction chamber 13 evacuated by the vacuum pump 23, the processing gas is supplied towards the semiconductor wafer W within the reaction chamber 13 through the gas supplying nozzles 16, and the power is applied to the reaction chamber 13 through the upper electrode 20 from the radio frequency power source 19. Then, the processing gas above the semiconductor wafer W is transformed into plasma and the plasma is used to process the semiconductor wafer W.

During the process, in order to uniformly process the surface of the semiconductor wafer W, the processing gas must be uniformly distributed above the semiconductor wafer W. Accordingly, the chuck 14 is rotatable through operation of the chuck rotating device 30 during the process, so that the processing gas can be uniformly distributed above the semiconductor wafer W.

Additionally, if the processing gas is concentrated at a particular region above the semiconductor wafer W during the process, the operator can activate the slant adjuster 50 and adjust the slant of the chuck 14, thereby guiding the processing gas to be uniformly distributed above the semiconductor wafer W. That is, as illustrated in FIG. 2, the operation of the driving motor 72 of the slant adjuster 50 causes the rotational shaft 53b to rotate, so that the supporting part 51 connected to the rotational shaft 53b is rotated, thereby allowing the slant of the upper surface of the chuck 14 to be adjusted in a desired direction and a desired angle.

The operator can adjust the slant of the chuck 14 through the operation of the slant adjuster 50 when non-uniform distribution of the processing gas is determined after detection of present conditions of the process. The present conditions of the process within the reactant chamber 13 can be observed through a detection window (not shown) provided at the body 11 to allow the interior of the reaction chamber 13 to be viewed therethrough or by a plurality of detection sensors (not shown) and the like. As such, a method for detecting a processing situation within a reaction chamber is well know in the art, and a detailed description thereof will be omitted.

As described above, a semiconductor manufacturing apparatus according to an embodiment of the present general inventive concept can rotate a chuck by use of a chuck rotating device during a manufacturing process and adjust a slant of the chuck by use of a slant adjuster, thereby ensuring that processing gas is uniformly distributed above a semiconductor wafer during the process. Furthermore, more uniform processing can be performed by use of these devices.

Additionally, in a semiconductor manufacturing apparatus according to an embodiment of the present general inventive concept, since coolant is supplied to a rotating chuck, it is possible to prevent a temperature of a semiconductor wafer from being raised during a manufacturing process.

Moreover, in a semiconductor manufacturing apparatus according to an embodiment of the present general inventive concept, since DC power is applied to a rotating chuck to cause the chuck to generate an electrostatic force, it is possible to securely mount a semiconductor wafer on the chuck.

Although a few embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. A semiconductor manufacturing apparatus, comprising:
a body having a reaction chamber formed therein to process a semiconductor wafer;
a chuck provided within the reaction chamber to support the semiconductor wafer;
a chuck rotating device provided within the reaction chamber to support and rotate the chuck; and
a slant adjuster to support the chuck rotating device and to adjust a position of the chuck rotating device to adjust a slant of an upper surface of the chuck.

2. The apparatus according to claim 1, wherein the slant adjuster comprises:
a supporting part to support the chuck rotating device within the reaction chamber; and
rotational shafts extending from opposite sides of the supporting part to rotate the supporting part while being supported at opposite sides of the body, respectively, each of the rotational shafts having a rotational axis crossing a rotational axis of the chuck rotating device.

3. The apparatus according to claim 2, wherein at least one of the rotational shafts extends externally of the body, and the slant adjuster further comprises:
a driving device provided at an outer surface of the body to rotate the at least one of the rotational shafts extending externally of the body in a clockwise or a counterclockwise direction.

4. The apparatus according to claim 2, wherein the chuck rotating device is disposed within the reaction chamber such that the rotational axis thereof is perpendicular to the upper surface of the chuck, and the slant adjuster is disposed within the reaction chamber such that a rotational axis of the slant adjuster is parallel to the upper surface of the chuck.

5. The apparatus according to claim 4, wherein the chuck rotating device comprises:
a rotating member coupled at one end to a lower surface of the chuck and rotatably supported by the supporting part; and
a driving device provided at the supporting part to rotate the rotating member in a clockwise or a counterclockwise direction.

6. The apparatus according to claim 5, wherein the rotating member has a cylindrical shape, and the driving device is provided at an outer surface of the rotating member.

7. The apparatus according to claim 6, wherein the supporting part and the rotational shafts are formed with a hollow space partitioned from the reaction chamber and communicating externally of the body, and the chuck rotating device is provided within the hollow space of the supporting part.

8. The apparatus according to claim 7, further comprising:
a first sealing member interposed between a lower surface of the chuck and an upper surface of the supporting part to maintain air-tightness between the hollow space of the supporting part and the reaction chamber.

9. The apparatus according to claim 7, further comprising:
a coolant circulation path formed in the chuck to circulate a coolant in the chuck and having an inlet and an outlet provided at the lower surface of the chuck;
a path connecting member provided at an inner center portion of the rotating member to contact the lower surface of the chuck and including a coolant supplying path and a coolant discharging path fixed in the supporting part and connected to the inlet and the outlet of the coolant circulation path, respectively; and
coolant pipes extending externally of the body from the coolant supplying path and coolant discharging path of the path connecting member through the supporting part and the rotational shafts.

10. The apparatus according to claim 9, wherein the inlet of the coolant circulation path is provided at a rotational center position of the chuck, the outlet of the coolant circulation path is provided at a position offset from the rotational center position of the chuck, the coolant supplying path and the coolant discharging path are provided at positions corresponding to the inlet and the outlet of the coolant circulation path, respectively, and the path connecting member is provided with a ring-shaped groove formed along a rotating trajectory of the outlet of the coolant circulation path at a top surface of the path connecting member to contact the lower surface of the chuck such that even if the chuck is rotated, the outlet of the coolant circulation path is connected to the coolant discharging path.

11. The apparatus according to claim 10, further comprising:
second sealing members respectively provided inner and outer portions of the ring-shaped groove between the lower surface of the chuck and the top surface of the path connecting member to partition the coolant supplying path from the coolant discharging path.

12. The apparatus according to claim 7, wherein the supporting part is provided therein with a brush-shaped power source connecting member to contact the rotating member to apply power to the chuck.

13. The apparatus according to claim 2, further comprising:
a first pin provided at the chuck to be lifted or lowered to separate the semiconductor wafer from the chuck;
a second pin provided at a position corresponding to the first pin to be raised or lowered in the supporting part to raise or lower the first pin; and
a lifter provided in the supporting part in order to raise or lower the second pin.

14. A semiconductor manufacturing apparatus, comprising:
a body having a reaction chamber formed therein to process a semiconductor wafer;
a chuck provided within the reaction chamber to support the semiconductor wafer; and
a slant adjuster rotatably provided at the body to support the chuck while adjusting a slant of the chuck.

15. The apparatus according to claim 14, wherein the slant adjuster comprises:
a supporting part to support the chuck;
and rotational shafts extending from opposite sides of the supporting part to rotate the supporting part while being supported at opposite sides of the body, respectively.

16. The apparatus according to claim 15, wherein at least one of the rotational shafts extends externally of the body, and the slant adjuster further comprises:
a driving device to rotate the at least one of the rotational extending externally of the body in a clockwise or a counterclockwise direction.

17. The apparatus according to claim 16, wherein the rotational shafts have rotational axis parallel to an upper surface of the chuck.

18. A semiconductor manufacturing apparatus, comprising:
a reaction chamber to process a semiconductor wafer therein; and
a chuck provided within the reaction chamber to mount the semiconductor wafer on a surface thereof and rotatable with respect to a first rotational axis perpendicular to the surface of the chuck and a second rotational axis parallel to the surface of the chuck.

19. The semiconductor manufacturing apparatus according to claim 18, further comprising:
a first rotational unit attached to the chuck to rotate the chuck with respect to the first rotational axis; and
a second rotational unit surrounding the first rotational unit to rotate the first rotational unit and the chuck with respect to the second rotational axis.

20. The semiconductor manufacturing apparatus according to claim 19, wherein the first rotational unit comprises:
a rotating member attached to the chuck and rotatable about the first rotational axis with respect to the second rotational unit; and
a driving unit to rotate the rotating member.

21. The semiconductor manufacturing apparatus according to claim 19, wherein the second rotational unit comprises:
a surrounding portion surrounding the first rotational unit and contacting the chuck;
at least on extending portion extending from the surrounding portion; and
a driving unit to transfer a rotational force to the extending portion to rotate the surrounding portion with respect to the second rotational axis.

22. A semiconductor manufacturing apparatus comprising:
a reaction chamber to process a semiconductor wafer therein;
a chuck provided within the reaction chamber to mount the semiconductor wafer thereon; and
a chuck adjustment unit to rotate the chuck and adjust a slant of the chuck within the reaction chamber.

23. The semiconductor manufacturing apparatus according to claim 24, wherein the chuck adjustment unit comprises:
a supporting portion to support the chuck within the reaction chamber;
a rotating member provided within the supporting portion and attached to the chuck to rotate the chuck with respect to the supporting portion;
a first driving unit to rotate the rotating member;
at least one extending portion extending externally of the reaction chamber from the supporting portion; and
a second driving unit to transfer a rotational force to the at least one extending portion to rotate the supporting portion and adjust the slant of the chuck.
